(19) United States
(12) Patent Application Publication
(10) Pub. No.: US 2023/0004476 A1
(43) Pub. Date: Jan. 5, 2023

(54) APPLICATION FAILURE TRACKING FEATURES

(71) Applicant: Hewlett-Packard Development Company, L.P., Spring, TX (US)

(72) Inventors: Marcus AVERY, Spring, CA (US); Satyadip NAG, Pune (IN); Manjiri Abhijit NARGUNDE, Pune (IN); Priyanka DAHAT, Pune (IN)

(21) Appl. No.: 17/852,541

(22) Filed: Jun. 29, 2022

(30) Foreign Application Priority Data
Jul. 1, 2021 (IN) 202141029602

(51) Int. Cl. G06F 11/36

(52) U.S. Cl. CPC G06F 11/366

(57) ABSTRACT

Examples described herein relate to systems and methods consistent with the disclosure. For instance, the system can comprise a processing resource, and a non-transitory machine-readable medium storing instructions executable by the processing resource determine when an application on the system is activated, monitor the application to determine an application failure using a tracking feature, take a snapshot of computing information related to the determined application failure, determine a coding language of the determined application failure, store the determined application failure, snapshot of computing information, and the coding language of the determined application to a memory device, and send the stored determined application failure, snapshot of computing information, and the coding language of the determined application to a server.

### BACKGROUND

Computing devices can include applications to perform tasks and functions on the system. For instance, a system can include a plurality of applications that allow a user to get online, draft documents, etc.

### BRIEF DESCRIPTION OF THE DRAWINGS

FIG. 1 illustrates an example of a system including a tracking feature.

FIG. 2 illustrates an example of an apparatus suitable with a system including a tracking feature.

FIG. 3 illustrates an example of a method for a system including a tracking feature.

FIG. 4 illustrates an example of a flow diagram including a system including a tracking feature.

FIG. 5 illustrates an example diagram of a non-transitory machine-readable medium suitable with a system including a tracking feature.

### DETAILED DESCRIPTION

Systems can be computer related devices that include applications thereon. Applications on a system can malfunction causing applications on the system to fail and/or not run as intended on the system. When an application malfunctions on a system it can be difficult to determine the cause of the malfunction. As such, it can be difficult to repair the damaged application so that the malfunction does not occur again. A user having to determine the cause of a malfunction before repairing the application can increase the time used to repair the application. In addition, a user not having access to previous malfunction data can increase the time used to repair the application.

Repairing an application on a system after a malfunction occurs can take time when the cause of the malfunction is unknown. That is, it can take time to gather information about the malfunction to determine the cause of the malfunction which can increase the time used to repair the malfunction of the application, as compared to being provided information about the malfunction.

As such, systems, as described herein, can provide a method, process, and/or apparatus that can provide information describing an application malfunction and reduce the time used to repair an application using a tracking feature, as compared to systems without a tracking feature. For example, a system can comprise a processing resource to determine when an application on the system is activated. In addition, the processing resource can monitor the application to determine an application failure using a tracking feature and take a snapshot of computing information related to the determined application failure. Moreover, the processing resource can determine a coding language of the determined application failure. After a processing resource have collected the data related to the application failure, the processing resource can store the determined application failure, snapshot of computing information, and the coding language of the determined application to a memory device and/or send the stored determined application failure, snapshot of computing information, and the coding language of the determined application to a server. Notably, such systems, including a tracking feature, can reduce the time used to fix an application, as compared to systems that do not include such tracking features. In addition, the tracking feature can assist in reducing the time to obtain information related to the malfunction and monitor the events that lead to the malfunction, thereby identify the actions that caused the malfunction.

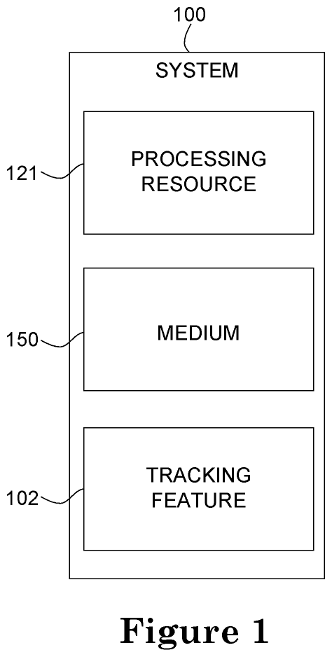

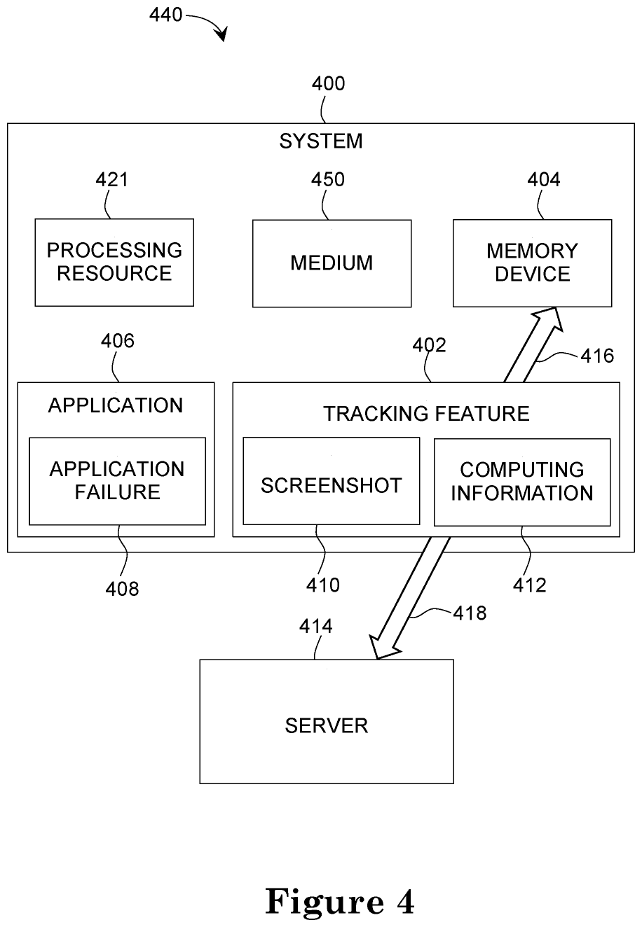

FIG. 1 illustrates an example of a system 100 including a tracking feature 102. The system 100 can be a variety of computing related devices, such as desktop computers, portable computers, tablets, etc. In some examples, the system 100 can be a desktop or portable computing device. The system 100 can include an application (i.e., application 408 of FIG. 4) thereon to assist in performing specific tasks. As used herein, an “application” refers to a collection of instructions and data that tell a computing related device how to execute specific tasks. In addition, the system 100 can include a tracking feature 102 to monitor an application on the system 100. In some examples, the tracking feature 102 can activate without user prompt when an application on the system 100 is activated. That is, the tracking feature 102 can run in the background until an application on the system 100 is activated. The tracking feature 102 can be used to gather computing information related to an application failure. The tracking feature 102 can gather computing information related to an application failure when the application is activated.

That is, the tracking feature 102 can monitor the application on the system 100 for application failures. In some examples, if an application on the system 100 has an application failure, the tracking feature 102 can identify the malfunction and determine that an application failure has occurred. In some examples, monitoring an application and gathering computing information related to an application failure can make it easier to identify issues with the application, as compared to a system that does not include a tracking feature 102. That is, the system 100 can use the computing information to identify issues with an application and inform a user and/or third-party what should be fixed on the application to prevent further application failures. As used herein, “application failure” refers to the act of an application not functioning as intended. As used herein, “computing information” refers to information that describes an application failure, events surrounding an application failure including event related to the hardware and/or software of the application.

In some examples, the tracking feature 102 can gather and store the computing information related to the application failure on the system 100 and provide easy access to the computing information. In some examples, the system 100 can include a processing resource 121 and a non-transitory machine-readable medium 150 to monitor an application of the system 100 using a tracking feature 102. The processing resource 121 can execute the instructions stored on the non-transitory machine-readable medium 150 to enable the tracking feature 102 on the system 100 to activate responsive to the activation of an application on the system 100. In some examples, the tracking feature 102 can activate to monitor an application and determine if the application is malfunctioning. In addition, the non-transitory machine-readable medium 150 can store instructions that can allow the processing resource 121 to determine computing information of an application of the system using the tracking feature 102. For instance, if the tracking feature 102 determines that an application failure has occurred on the application, the tracking feature 102 can determine what caused the application failure and gather the information to create computing information. The computing information can be information that can explain what caused the application failure to a user and/or third party. In some examples, the tracking feature 102 can generate an information request for additional computing information. For instance, once the tracking feature 102 determined the computing information, the tracking feature 102 can ask a user and/or third party to provide additional computing information related to the application failure. The additional computing information can be information related to the cause of the application failure provided by the user and/or third-party.

In some examples, the tracking feature 102 can also take a snapshot related to the application failure. That is, the tracking feature 102 can locate what caused the application failure and take a snapshot of what caused the application to malfunction. The snapshot can provide the user and/or a third-party information that can assist with remedying the application. In some examples, the snapshots can be attachments added to the computing information in the form of a recording, a still image, etc. In some examples, the tracking feature 102 can generate an information request for additional snapshots. For instance, once the tracking feature 102 takes a snapshot related to the application failure, the tracking feature 102 can ask a user and/or third party to provide additional snapshot related to the application failure. The additional snapshot can be a still image or recording related to the cause of the application failure that is provided by the user and/or third party. As used herein, “snapshot” refers to recordings, still images, etc. related to an application. For example, the snapshot related to an application failure can be a visual copy of the coding language for the same application failure, a still image of what is on display screen around the time (e.g., immediately before, during, immediately after) the application failure occurs, etc. That is, the information related to the application failure can also provide information related how the failure is experienced.

In some examples, the tracking feature 102 can notify the user and/or third-party of an application failure and provide the user and/or third-party with computing information and snapshots related to the application failure. In various examples, the processing resource can cause the tracking feature 102 to prompt a user and/or third-party for identification before to notifying the user of the determined failure. In addition, the non-transitory machine-readable medium 150 can include instructions executable by a processing resource 121 to generate information request for an additional snapshot and computing information related to the application failure. In some examples, the non-transitory machine-readable medium 150 can include instructions executable by a processing resource 121 to generate information request for feedback related to the determined failure, responsive to notifying the user of the determined failure. That is, the processing resource 121 can cause the tracking feature 102 to request additional snapshot and additional computing information from a user and/or third-party.

In some examples, the processing resource 121 can cause the tracking feature 102 to store the computing information and the snapshot on the memory device. The computing information and snapshot can be stored on the memory device to provide a user and/or a third-party access to information related to the application failure. The information stored on the memory device can be used to allow a user and/or third-party to fix the application quickly, as compared to fixing the application without using the computing information and snapshot stored in the memory device. In addition, the additional computing information and additional snapshot can be stored on the memory device to provide access to the information.

In some examples, the processing resource 121 can cause the tracking feature 102 to send the computing information and the snapshot to a server. The computing information and snapshot can be stored on the server to provide access to the computing information and snapshot to a third-party and/or a user. The information sent to the server can be used to fix the application and allow the information related to a current application failure be compared to information related to an earlier application failure. In some examples, comparing earlier computing information and snapshots to a current computing information and snapshot can allow a user and/or third-party to understand the current issue with an application and reduce the time to fix the application, as compared not being able to compare previous computing information and snapshots to a current computing information and snapshot. As used herein, a “server” refers to a computer device and/or computer program that manages access to a resource and/or service in a network.

In some examples, including a tracking feature 102 on the system 100 can reduce the time taken to fix an application on the system 100 due to the sharing of the information related to the application failure. That is, if a system 100 did not include a tracking feature 102 that monitored the application and provided a user and/or third-party with information related to the application failure, the time taken to fix the application failure could increase. In addition, the computing information and snapshot can provide a user and/or third-party with the specific actions performed that cause the application failure. In some examples, knowing the specific actions that caused the application failure can reduce the time it takes to fix the application, as compared to not having the specific actions performed that caused the application failure.

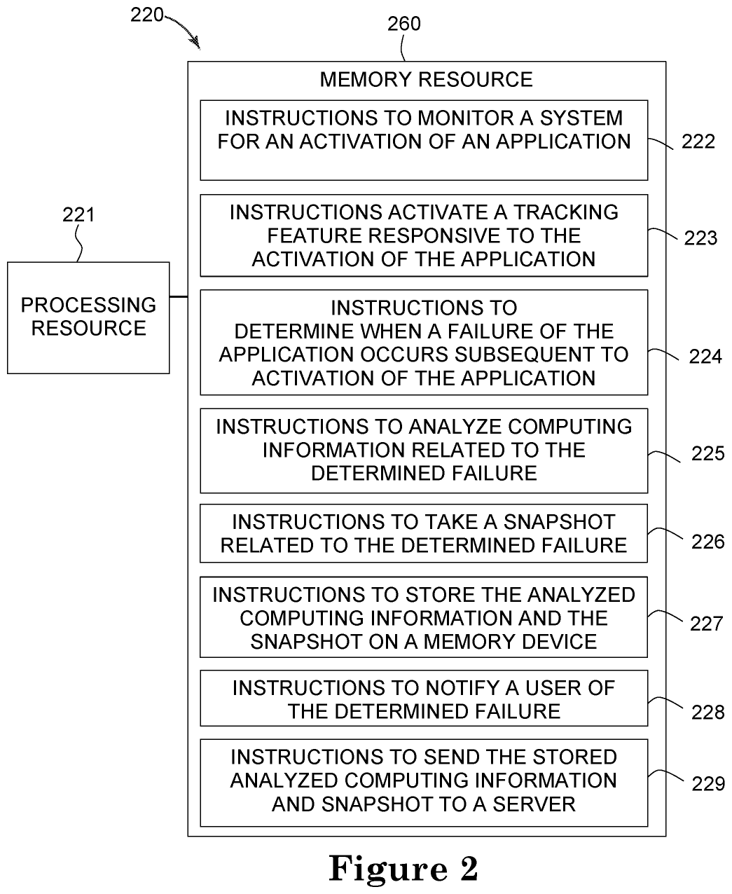

FIG. 2 illustrates an example of an apparatus 220 suitable with a system including a tracking feature. As illustrated in FIG. 2, the apparatus 220 includes a processing resource 221 and a memory resource 260. The processing resource 221 is a hardware processing device such as a microprocessor, application specific instruction set processor, coprocessor, network processor, or similar hardware circuitry that causes machine-readable instructions to be executed. In some examples, the processing resource 221 can be a plurality of hardware processing devices that can cause machine-readable instructions to be executed. The processing resource 221 can include central processing devices (CPUs) among other types of processing devices. The processing resource 221 can also include dedicated circuits and/or state machines, such as in an Application Specific Integrated Circuit (ASIC), Field Programmable Gate Array (FPGA) or similar design-specific hardware. The memory resource 260 can be any type of volatile or non-volatile non-transitory memory, such as random-access memory (RAM), flash memory, read-only memory (ROM), storage volumes, a hard disk, or a combination thereof.

The memory resource 260 can store instructions thereon, such as instructions 222, 223, 224, 225, 226, 227, 228 and 229. When executed by the processing resource 221, the instructions can cause the apparatus 220 to perform specific tasks and/or functions. For example, the memory resource 260 can store instructions 222, that when executed by the processing resource 221, cause the processing resource 221 to monitor a system for an activation of an application. A system (e.g., system 100 of FIG. 1) can include a processing resource 221 and a memory resource 260. The processing resource 221 can allow the tracking feature to monitor the activity of other applications on the system. In some examples, the tracking feature can watch other applications on the system to determine when other applications on the system are activated. Determining when other applications of the system are activated can allow the tracking feature to activate when other applications are activated, allowing the tracking feature to monitor the other applications for failures. The tracking feature activating when other applications activate can reduce amount of energy (e.g., processing power) used by the system, compared to a tracking feature that is constantly activated while the system is on. That is, in some examples, the tracking feature can activate when the tracking device determines that an application of the system has activated.

The memory resource 260 can store instructions 223, that when executed by the processing resource 221, cause the processing resource 221 to activate a tracking feature responsive to the activation of the application. In some examples, a system can include many applications. Some applications can malfunction when being used by the system. As such, the processing resource 221 can cause a tracking feature to activate when an application is activated. That is, the processing resource 221 can cause the tracking feature to monitor the applications on the system for an application activation. Further, when the tracking features identifies that an application is in use, the tracking feature will activate substantially simultaneously with the application that was activated.

In some examples, the tracking feature can monitor a plurality of applications for activations. For example, the tracking feature can monitor a first application for an activation and the tracking feature can activate responsive to the first application activating. While the tracking feature is activated and monitoring the first application, the tracking feature can be monitoring other applications on the system to determine when a second application of the system is activated. If a second application of the system is activated the tracking device can monitor both the first application and the second application substantially simultaneously. The tracking feature when activated can monitor an activated application and/or a plurality of activated applications to determine when a malfunction occurs on the activated application(s). That is, the processing resource 221 can cause the tracking feature to activate for a plurality of applications responsive to activating the corresponding plurality of applications.

The memory resource 260 can store instructions 224, that when executed by the processing resource 221, cause the processing resource 221 to determine when a failure of an application occurs subsequent to activation of the application. When an application is activated on a system, issues can occur. It can be difficult for a user to identify the different issues that occur while using the application. As such, a tracking feature can be used to determine what application failures exist on the application. This can help quickly identify and remedy the issues, as compared to systems that do not have a tracking feature that can associate with applications on the system. In some examples, the processing resource 221 can cause the tracking feature to monitor a plurality of applications on the system. In addition, the tracking feature can determine application failures for the plurality of applications substantially simultaneously.

In some examples, the tracking feature can gather computing information related to an application failure which can allow the tracking feature to determine specific issues associated with the application and identify specific application failures. The tracking feature can monitor all applications of a system without information on how the application runs on the system. That is, the tracking feature can determine when the application is activated, monitor the application for failures without particular information on the applications coding language. In some examples, the tracking feature can analyze the computing information it receives from the application when it determines the application failure.

The memory resource 260 can store instructions 225, that when executed by the processing resource 221, cause the processing resource 221 to analyze computing information related to the determined failure. In some examples, the tracking feature can analyze the application failure to provide computing information to a user and/or third-party. For example, the tracking feature can determine the coding language of a particular application failure. In some examples, the non-transitory machine-readable medium storing instructions executable by a processing resource to cause the tracking feature to determine the coding language of the application failure. In various examples, the coding language of the application failure can allow the user and/or third-party to determine what remedies may be needed to fix the application failure. That is, the processing resource 221 can cause the tracking feature to determine and analyze the failures of the application while monitoring the application. In some examples, the processing resource 221 can cause the tracking feature to analyze a plurality of application failures from different applications. For instance, the tracking feature can analyze computing information from multiple applications and determine the coding language for a plurality of application failures from different applications.

The memory resource 260 can store instructions 226, that when executed by the processing resource 221, cause the processing resource 221 to take a snapshot related to the determined application failure. In some examples, the processing resource 221 can cause the tracking feature to capture a snapshot related to the application failure. The snapshot can be additional information related to the application failure. That is, the snapshot can provide additional visual information to explain what caused the application failure.

The memory resource 260 can store instructions 227, that when executed by the processing resource 221, cause the processing resource 221 to store the analyzed computing information and the snapshot on a memory device. In some examples, the processing resource 221 can cause the tracking feature to store the computing information and the snapshot. For example, the computing information and the snapshot can be stored on a memory device. Storing the computing information and snapshot can provide readily available information related to application failure for current and future use. In addition, the processing resource 221 can cause the tracking feature to store coding language of the application failure on the memory device.

The memory resource 260 can store instructions 228, that when executed by the processing resource 221, cause the processing resource 221 to notify a user and/or third-party of the determined failure. In some examples, the processing resource 221 can cause the tracking feature to notify the user of the application failure. That is, the tracking feature can inform the user that an application failure has occurred by providing the user and/or third-party with computing information and the snapshot related to the application failure. Specifically, the processing resource 221 can cause the tracking feature to notify the user and/or third-party of the computing information, snapshot and the coding language related to the application failure. Notifying the user and/or third-party to the application failure can allow the user and/or third-party to understand why the application is malfunctioning and allow the user and/or third-party to provide additional information as to the application failure. In some examples, the tracking feature can notify the user and/or third party by sending an email including computing information, snapshots, and coding language to the user and/or third-party.

The memory resource 260 can store instructions 229, that when executed by the processing resource 221, cause the processing resource 221 to send the stored analyzed computing information and snapshot to a server. In addition to storing the computing information and the snapshot on the system, the computing information and snapshot can be sent to a server for storage as well. In some examples, the computing information is sent to the server for a user and/or third-party to have access to the information and assess the issues with the application. In addition, the tracking feature can send the coding language to the server for storage.

In some examples, the server can create an application failure identification for each application failure received. The server can send the application failure identification back to the system. In some examples, the processing resource 221 can cause the tracking feature to receive the application failure identification and allow access to the application failure through the application failure identification.

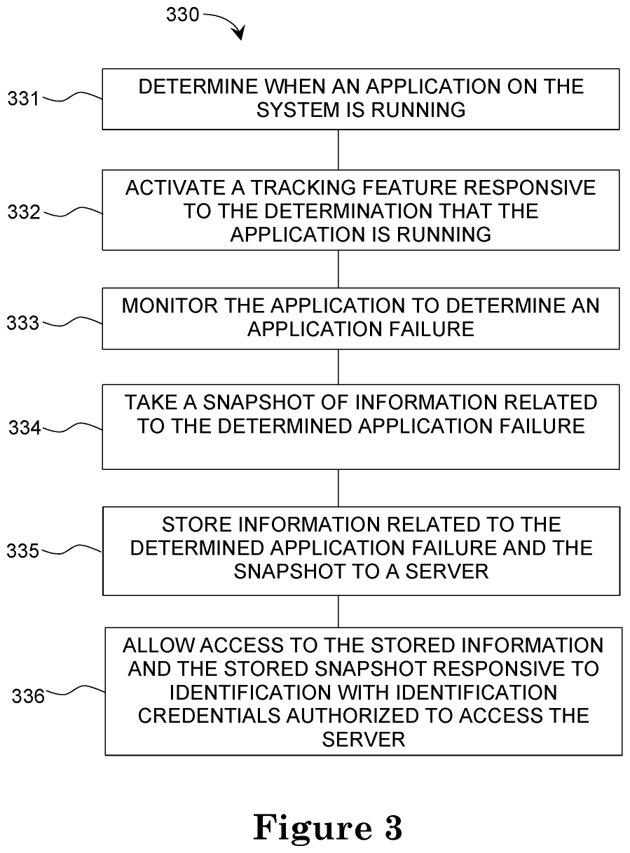

FIG. 3 illustrates an example of a method 330 for a system including a tracking feature. Method 330 can be performed, for example, by a processor resource (e.g., processor resource 221 of FIG. 2) of apparatus (e.g., apparatus 220 of FIG. 2). The method 330 can be performed with more or less elements.

At 331, the method 330 can include determining when an application on a system (e.g., system 100 of FIG. 1) is running. A system can include a tracking feature used to determine application failures. For example, the tracking feature can run in the background of the system. That is, the tracking feature can run using minimal system resources and perform tasks which require little to no input from the user until an event occurs or a condition is met. For example, the tracking feature can run in the background of the system monitoring the applications on the system to determine if an application is activated. In some examples, when it is determined that an application is running (e.g., activated), the tracking feature can activate and begin to use the necessary system resource to monitor the application for an application failure.

At 332, the method 330 can include activating a tracking feature responsive to the determination that the application is running. The tracking feature can run in the background until an application is activated. Once the tracking feature determines that an application is activated the tracking feature can run at full capacity and monitor the application for application failures. In some examples, the tracking feature can activate substantially simultaneously with the application that was recently activated. The tracking feature can activate to monitor the recently activated application. In some examples, if the tracking feature is activated by a first application, the tracking feature can begin to monitor a second subsequently activated application simultaneously. That is, once the tracking feature is activated it can monitor multiple activated applications.

At 333, the method 330 can include monitoring the application to determine an application failure. In some examples, determining when an application has a failure can reduce the time for fixing the issue with the application, as compared to systems that do not include a feature to track application failures. In addition, the tracking feature monitoring the application for application failures can gather computing information related to the application failure. The computing information can reduce the communication time when fixing the issues with the application. That is, the computing information can provide a user and/or third-party with information about the events on the application that lead to the application failure. Providing information about the events leading up to the application failure can reduce the time it takes to fix the application, as compared to not providing information about the events leading up to the application failure. The tracking feature can provide all of the computing information related to the application failure to a user and/or third-party and the user and/or third-party can use the computing information to fix the application.

At 334, the method 330 can include taking a snapshot of information related to the determined application failure. The tracking feature can take snapshots of the application failure to assist in identifying the issue with the application. In some examples, snapshot can be a recording of events leading to the application failure to provide a user with a better understanding of the failure. In various examples, the snapshot can be a still image of events leading to the application failure that can provide a user with a better understanding of the application failure. That is, the snapshot can be an additional attachment to the computing information that can assist in remedying the application when an application failure has occurred.

At 335, the method 330 can include storing information related to the determined application failure and the snapshot to a server. In some examples, the computing information and snapshot can be sent to a server so that it can be accessed by a user and/or a third-party that can use the information to fix the application. In various examples, the server can analyze the computing information and snapshot related to an application failure and provide it with an identification code so that the particular computing information and the particular snapshot is linked to the proper application failure. The server can then send the computing information including the snapshot back to the system with the identification code.

At 336, the method 330 can include allowing access to the stored information and the stored snapshot responsive to identification with identification credentials authorized to access the server. The user and/or a third-party can use the computing information and the snapshot to fix the application failure. However, in some examples, the user and/or third-party can provide credentials that show a user and/or third-party is allowed to access the information. That is, once authorization is proven the tracking feature can provide the requester information related to the application failure.

In various examples, the processing resource can cause a tracking feature to determine when an application on the system is running and activate responsive to the determination that the application is running. In addition, the processing resource can cause a tracking feature to monitoring the application to determine an application failure and take a snapshot of information related to the determined application failure. In some examples, the processing resource can cause a tracking feature to gather computing information related to the application failure. Providing computing information and snapshot to a user and/or third-party can reduce the amount of time used to repair the application, as compared to not being provided computing information and a snapshot related to the application failure.

FIG. 4 illustrates an example of a flow diagram 440 including a system 400 including a tracking feature 402. For example, FIG. 4 can include a system 400, a processing resource 421, a medium 150, and a tracking feature 502.

In some examples, a system 400 can include a processing resource 421, a medium 450, and a tracking feature 402. The system 400 can allow a tracking feature 402 to determine when an application failure 408 occurs. In some examples, an application 406 can malfunction when being used on the system 400. It can be difficult to determine the issue with the application 406. A tracking feature 402 can be used to identify application failures 408 and assess the issue with the application 406. That is, the tracking feature 402 can provide computing information 412 and snapshots 410 related to the application failure 408.

In some examples, the tracking feature 402 can determine computing information 412 to describe the application failure 408 and/or the cause of the application failure 408. That is, the computing information 412 can include analysis of the application failure. For instance, the tracking feature 402 can determine whether the application failure 408 is related to the software, hardware, coding, etc. and provide the analysis as computing information 412.

In some examples, the tracking feature 402 can create snapshot 410 related to the application failure 408. The snapshot 410 can provide a visual image of the application failure 408. The tracking feature 402 can use the snapshot 410 to provide a better understanding on what cause the application failure 408. That is, the snapshot 410 can be a still image of the application failure 408, a recording of events leading up to the application failure 408 and/or a recording of events after the application failure 408, an image of the coding language, etc. For instance, the tracking feature 402 can take a plurality of snapshots 410 when an application failure 408 occurs to provide an understanding of the application failure 408.

The tracking feature 402 can send the computing information 412 and the snapshot 410 to a memory device 404 of the system 400 through channel 416. The memory device 404 can be used to store computing information 412 and snapshot 410 related to an application failure 408. A user can access the computing information 412 and the snapshot 410 related to an application failure 408 to understand the issue with the application 406. Using the computing information 412 and the snapshot 410 related to an application failure 408 to fix the application 406. In some examples, the application 406 can be fixed faster using the computing information 412 and the snapshot 410 related to an application failure 408, as compared to not using the computing information 412 and the snapshot 410. That is, the tracking feature 402 provides information that allows an application to be quickly fixed.

In some examples, the tracking feature 402 can send the computing information 412 and the snapshot 410 related to an application failure 408 to a server 414, through channel 418. That is, the server 414 can be used to store the computing information 412 and the snapshot 410 related to an application failure 408 and allow an authorized third party to access the information on the server 414. In some examples, the server 414 can provide identification code to each computing information 412 and snapshot 410 so that each computing information 412 and snapshot 410 is connected with the proper application failure 408.

In some examples, the tracking feature 402 of the system 400 can be used to reduce the time to fix an application 406 on the system 400 by determining that an application failure 408 has occurred and creating computing information 412 and snapshots 410 relating to the application failure 408 and providing that information to a user. For instance, the non-transitory machine-readable medium 450 can store instructions executable the processing resource 421 to determine when an application 406 on the system 400 is activated, monitor the application 406 to determine an application failure 408 using a tracking feature 402, take a snapshot 410 of computing information 412 related to the determined application failure 408, determine a coding language of the determined application failure 408, store the determined application failure 408, snapshot 410 of computing information 412, and the coding language of the determined application 406 to a memory device 404, and send the stored determined application failure 408, snapshot 410 of computing information 412, and the coding language of the determined application 406 to a server 414. In some examples, the processing resource 421 can cause the tracking feature 402 to generate an information request for additional snapshot 410 and/or computing information 412 responsive to the determining an application failure 408 occurred. For instance, the tracking device 402 can ask the user to provide computing information 412 and/or snapshots 410 related to the application failure 408.

In some examples, the tracking feature 402 can notify the user of the application failure 408 when a user is verified as an authorized user. For example, the processing resource 421 can cause the tracking feature 402 to generate an information request for identification of a user, and notify the user of the determined application failure 408 responsive to receiving the information request.

In some examples, the application 406 can be a website or a system application that communicates with the tracking feature 402. In some examples, the tracking feature 402 can communicate with the application 406 through an Application Programming Interface. The Application Programming Interface can allow the tracking feature 402 to monitor a computing device for an activation of an application 406, activate the tracking feature 402 responsive to the activation of the application 406, determine when an application 408 failure of the application 406 occurs subsequent to activation of the application 406, analyze computing information 412 related to the determined application failure 408, take a snapshot 410 of computing information 412 related to the determined application failure 408, notify a user and/or third-party of the determined application failure 408, store the analyzed computing information 412 and the snapshot 410 on a memory device 404, via channel 416, and send, via channel 418, the stored analyzed computing information 412 and snapshot 410 to a server 414.

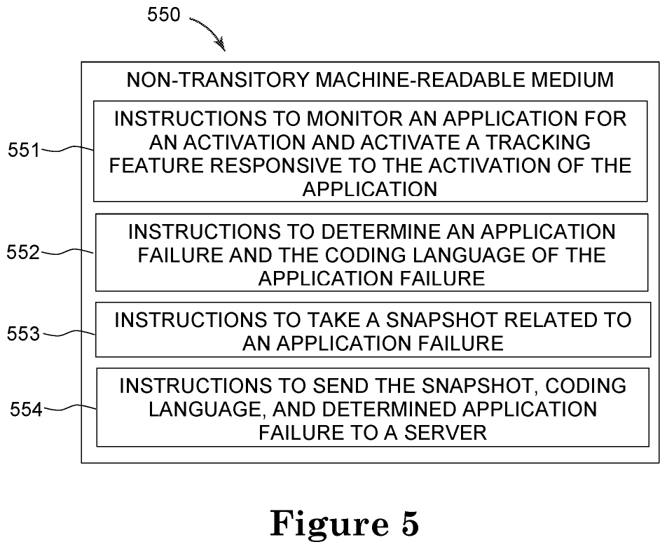

FIG. 5 illustrates an example diagram of a non-transitory machine-readable medium 550 suitable with a system including a tracking feature. The non-transitory machine-readable medium 550 can be any type of volatile or non-volatile non-transitory memory, such as random-access memory (RAM), flash memory, read-only memory (ROM), storage volumes, a hard disk, or a combination thereof.

The medium 550 stores instruction 551 executable by a processing resource to monitor an application for an activation and activate a tracking feature responsive to the activation of the application. In various examples, the processing resource can execute observe instructions 551 to monitor the system and the applications of the system. The processing resource can cause the tracking feature to determine if an application is activated. In addition, if it is determined that the application is activated, then the tracking feature can become fully activated. That is, the tracking feature can run in the background of the system and monitor the applications on the system for activity. Once an application is activated the tracking feature can completely activate and monitor the application for failures that can occur. Hence, the tracking feature can monitor the system for application activations and monitor the activated applications for application failures.

In some examples, the tracking feature can activate when it is determined that an application of the system is activated. In some examples, the tracking feature can activate and use an Application Programming Interface to interact with the application. That is, the tracking feature can determine when a failure in the application occurs and document the type of failure and information related to the application failure as computing information. For instance, the tracking feature can analyze the application failure and determine information related to the application failure. For instance, the tracking feature can determine what caused the application failure, which aspect of the application malfunctioned, the time the malfunction occurred, the events leading up to the malfunction, the events that occurred after the malfunction, etc. In some examples, the information obtained by the tracking feature can assist in diagnosing the issue with the application. In addition, the computing information obtained by the tracking feature can make the recovery of the application faster, as compared to fixing the application without computing information obtained by the tracking feature.

The medium 550 stores instruction 552 executable by a processing resource to determine an application failure and the coding language of the application failure. In some examples, the processing resource can execute determine instructions 552 to monitor the system and the applications of the system. In various examples, the tracking feature can analyze the application failure to determine the coding language associated with the application failure. The determining the coding language associated with the application failure can provide the user with information to remedy the application failure before a thorough assessment is made. For instance, if an application malfunctions because of erroneous coding language, the user and/or third-party will be notified and can quickly fix the application with the provided information. In addition, the coding language of the application failure can be used to assess the issue with the application. For instance, the coding language can provide understanding of the issue with the application and allow a user or other person to fix the application failure promptly.

The medium 550 stores instruction 553 executable by a processing resource to take a snapshot related to an application failure. In various examples, the processing resource can execute capture instructions 553 to capture screenshots related to the application failure. The snapshot taken by the tracking feature can provide a better understanding of the application failure. For instance, the snapshots related to the application failure can be used to identify specific issue in the application. In some examples, the snapshots can be attachments added to the computing information in the form of recordings, a still image of the screen when the application failed, a still image of the coding language, etc.

The medium 550 stores instruction 554 executable by a processing resource to send the snapshot, coding language, and determined application failure to a server. In various examples, the processing resource can execute transfer instructions 554 to transfer the snapshot, coding language, and determined application failure to a server. In some examples, the processing resource can cause the tracking feature to store computing information including the snapshot and the coding language on the server. The server can provide identification information that connects the computing information to a particular application failure. In some examples, the computing information can be stored based on the application failure. For instance, each application failure has its own computing information and each computing information related to an application failure is stored in a separate location from other computing information related to another application failure.

The figures herein follow a numbering convention in which the first digit corresponds to the drawing figure number and the remaining digits identify an element or component in the drawing. Similar elements or components between different figures can be identified by the use of similar digits. For example, 102 can reference element “02” in FIG. 1, and a similar element can be referenced as 402 in FIG. 4.

Elements shown in the various figures herein can be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

The above specification and examples provide a description of the method and applications and use of the system and method of the present disclosure. Since many examples can be made without departing from the scope of the system and method, this specification merely sets forth some of the many possible example configurations and implementations.

It should be understood that the descriptions of various examples may not be drawn to scale and thus, the descriptions can have a different size and/or configuration other than as shown therein.

What is claimed:

1. A system comprising:
a processing resource; and
a non-transitory machine-readable medium storing instructions executable the processing resource to:
determine when an application on the system is activated;
monitor the application to determine an application failure using a tracking feature;
take a snapshot of computing information related to the determined application failure;
determine a coding language of the determined application failure;
store the determined application failure, snapshot of computing information, and the coding language of the determined application to a memory device; and
send the stored determined application failure, snapshot of computing information, and the coding language of the determined application to a server.

2. The system of claim 1, further comprising instructions to generate an information request for an additional snapshot of computing information responsive to the determined application failure.

3. The system of claim 1, wherein the tracking feature is controlled on the application responsive to the activation of the application.

4. The system of claim 1, further comprising instructions to:
generate an information request for identification; and
notify a user of the determined failure responsive to receiving the information request.

5. The system of claim 1, wherein the application is a website or a computing device application that communicates with the tracking feature.

6. A non-transitory machine-readable medium storing instructions executable by a processing resource to:
monitor a computing device for an activation of an application;
activate a tracking feature responsive to the activation of the application;
determine when a failure of the application occurs subsequent to activation of the application;
analyze computing information related to the determined failure;
take a snapshot related to the determined failure;
notify a user of the determined failure;
store the analyzed computing information and the snapshot on a memory device; and
send the stored analyzed computing information and snapshot to a server.

7. The non-transitory machine-readable medium of claim 6, further including instructions to generate information request for an additional snapshot of computing information related to the determined failure.

8. The non-transitory machine-readable medium of claim 6, further including instructions to:
determine the coding language of the determined failure; and
notify the user of the coding language of the determined failure.

9. The non-transitory machine-readable medium of claim 8, further including instructions to:
store the coding language on the memory device; and
send the stored coding language to the server.

10. The non-transitory machine-readable medium of claim 6, further including instructions to generate information request for feedback related to the determined failure, responsive to notifying the user of the determined failure.

11. The non-transitory machine-readable medium of claim 6, further including instructions to prompt the user for identification before to notifying the user of the determined failure.

12. A method comprising:
determining when an application on the system is running;
activating a tracking feature responsive to the determination that the application is running;
monitoring the application to determine an application failure;
taking a snapshot of information related to the determined application failure;
storing information related to the determined application failure and the snapshot to a server; and
allowing access to the stored information and the stored snapshot responsive to identification with identification credentials authorized to access the server.

13. The method of claim 12, further comprising:
activating the tracking feature for a plurality of applications responsive to activating the corresponding plurality of applications;
determining application failures for the plurality of applications substantially simultaneously;
analyzing information related to the determined application failures; and
sending the information to the server.

14. The method of claim 13, further comprising storing the information related to the determined application failure for each application of the plurality of application separately.

15. The method of claim 12, further comprising:
analyzing the coding language of the determined application failure; and
providing the analyzed coding language to a user.
